(19) United States
(12) Patent Application Publication
(10) Pub. No.: US 2023/0051294 A1
(43) Pub. Date: Feb. 16, 2023

(54) SYSTEM AND METHOD FOR DETERMINING AND ASSIGNING AN OPTIMAL VALUE ASSOCIATED WITH A PROPERTY UNIT USING A SHORT-TERM PREDICTOR

(71) Applicant: Bungalow Living, Inc., San Francisco, CA (US)

(72) Inventors: Gergely Ferenc KORODI, Waterloo (CA); Britton STAMPER, Boise, ID (US); Emma DAKE, San Francisco, CA (US); Amr SHAFIK, Miami, FL (US)

(21) Appl. No.: 17/885,287

(22) Filed: Aug. 10, 2022

Related U.S. Application Data
(60) Provisional application No. 63/231,754, filed on Aug. 11, 2021.

(51) Int. Cl. G06Q 30/06; G06Q 50/16; G06Q 30/02

(52) U.S. Cl. CPC G06Q 30/0611; G06Q 50/163; G06Q 30/0205

(57) ABSTRACT

A method and system in which the system receives input data for a first unit to determine a unit feature signal and a unit demand signal including predictive demand features. The system then determines, for the first unit at each of a plurality of offer values, a set of associated estimated probabilities that the offer value will be accepted within a short-term time period; determines an expected time-to-sell for the first unit at each of the plurality of offer values; determines an optimal offer value for the first unit; and displays the optimal offer value for the first unit on a webpage.

### CROSS-REFERENCE TO RELATED APPLICATIONS

This patent claims the benefit of U.S. Provisional Patent Application No. 63/231,754, filed Aug. 11, 2021. U.S. Provisional Patent Application No. 63/231,754 is hereby incorporated herein by reference in its entirety. Priority to U.S. Provisional Patent Application No. 63/231,754 is hereby claimed.

This application relates to the generation of optimal offer values for property units (e.g., rental units and buyer-owned units) using a short-term predictor.

### FIELD

The present application relates to the generation of optimal offer values for property units (e.g., rental units and buyer-owned units).

### BACKGROUND

Each unit of inventory, especially in real estate, has a unique combination of unit characteristics, subunit characteristics, location-specific dynamics, and seasonal trends that must be taken into account if the optimal offer value is to be determined. A higher offer value may provide higher revenue once a sale occurs but may require a waiting period before acceptance and sale during which the associated revenue is zero. A lower offer value may provide a faster sale and a shorter waiting period, but lower total revenue over time. Determining optimal offer values for real estate property units can be complex, particularly when the property units have wide variations in characteristics, sell at many, infrequent intervals and are highly influenced by seasonality. As a result, offer value determinations are therefore often left to simple comparison and guesswork.

Historical pricing methods used in the industry involve using a series of spreadsheet calculations to attempt to forecast some of the nuances of inventory pricing. Better attempts to optimize the annual revenue of property units have involved constant human intervention with extremely complex systems, involving calculations and patterns that have been difficult for people to interpret due to the number of variables contributing to an offer value determination. When a unit is not leasing or selling quickly, there may be an offer value re-evaluation during the time-to-sell period. In these instances, due to the inadequate nature of historical offer value determination, a property unit may very often be unwittingly underpriced, resulting in missed revenue at a higher offer value that would have had the same, or a slightly longer, time-to-sell period.

As a result, pricing decisions are often made in simple ways, for example, by applying a fixed percentage increase to attempt to account for inflation over time. Broad pricing actions may also be taken into account for market effects, such as a large influx or outflux of people into particular geographic areas, resulting in all units of inventory receiving the same price increase or reduction without a clear analysis for that particular unit.

### BRIEF DESCRIPTION OF THE DRAWINGS

Reference will now be made, by way of example, to the accompanying drawings in which:

FIG. 1 is a schematic operation diagram illustrating an operating environment of an example embodiment;

FIG. 2 is a simplified schematic diagram showing components of a computing device;

FIG. 3 is a high-level schematic diagram of an example computing device;

FIG. 4 shows a simplified organization of software components stored in a memory of the example computing device of FIG. 3;

FIG. 5 is a schematic diagram of the components of a system in accordance with one embodiment;

FIG. 6 is a flowchart of a method for training a short-term lease predictor, in accordance with one embodiment;

FIG. 7 is a chart showing the relationship between probability and class index, in accordance with one embodiment;

FIG. 8 is a chart containing example data; and

FIG. 9 shows, in flowchart form, one example method performed by an application server in real estate management according to an embodiment.

Like reference numerals are used in the drawings to denote like elements and features.

### DETAILED DESCRIPTION

Embodiments described herein may include a system and method to assign offer values to individual units. In some embodiments, the units may be rental units in the form of individual rooms for rent or may be entire properties for rent. In some embodiments, the units may be individual rooms for sale or may be entire properties for sale.

It may be desirable to maximize the annual revenue obtained by leasing the unit for a duration of time. The annual revenue is a function of the offer value (i.e., the price) that a lease is signed for and the time-to-sell period incurred, wherein time-to-sell for a unit generates no revenue and leased units generate fixed revenue. In order to maximize the annual revenue, the expected time-to-sell as a function of price may be determined. An algorithm that accurately predicts the expected time-to-sell at various price points may enable computation of the optimal offer value which maximizes the annual revenue.

In some embodiments, there is provided an automated approach in which a computer system factors in the drivers behind optimal pricing. This approach may provide users with easier access to informed pricing decisions. The system's recommendations may surface in internal tools that allow the recommendations to be actioned upon by a user. Decisions may be largely made by the computer system with optional human intervention when information exists outside of that which the system evaluates.

In some embodiments, the automated approach may provide automated pricing that gives control over pricing decisions to the computer system. The computer system may then be able to rapidly respond to any signals that are read for a particular unit and reprice the unit to maximize revenue. The computer system may operate within business guardrails such that the economics of the unit fit within the necessary bounds to operate profitably and deliver on customer expectations.

By reducing human driven analysis and decision making, pricing actions may be executed significantly more often and may result in significant revenue gains by optimizing the trade-off between offer value and time-to-sell. More accurate computer-driven decisions may allow for mispriced units to be increased or decreased in price to maximize revenue.

Some automated pricing systems may attempt to determine an optimal price for a unit using a plurality of input metrics and a global optimization expression that accounts for those plurality of input metrics. This can result in a system that is too complex and slow to realize a price value in a reasonable period of time. It can also results in a system that consumes excessive memory and processor resources in its exhaustive search for an optimal price. In some cases, an exhaustive globally optimal solution is not practical to implement using real-world computing resources. It would be advantageous to realize a computer system capable of automatically determining an optimal price that reduces the memory requirements and/or the processing time for determining the optimal price.

The term “optimal price” or “optimal offer value” or the like are not intended to indicate that the resultant value is a globally optimized value accounting for all metrics available in a mathematical sense. The “optimal” value may be based on a localized maximum or minimum, with regard to certain constraints or a time window of analysis in some cases.

According to the subject matter of the present application, there may be provided a computer-implemented method for determining an optimal offer value for a first unit for display on a webpage, the method comprising: receiving unit feature data for the first unit; determining, based on the unit feature data, a unit feature signal; receiving unit demand data for the first unit at a current offer value; determining, based on the unit demand data, a unit demand signal, the unit demand signal including predictive demand features; determining, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value; determining, based on the set of associated estimated probabilities, an expected time-to-acceptance for the first unit at each of the plurality of offer values; determining an optimal offer value for the first unit using the expected time-to-acceptance for the first unit at the plurality of offer values; and displaying the optimal offer value for the first unit on the webpage.

In some implementations, determining, based on the unit feature data, the unit feature signal comprises processing and combining the unit feature data into a single unit feature data score.

In some implementations, the method further comprises storing the optimal offer value for the first unit; transmitting the optimal offer value for the first unit to a unit-owner computing device; and receiving an approval response from the unit-owner computing device.

In some implementations, determining, for the first unit at each of the plurality of offer values, the set of associated estimated probabilities that the offer value will be accepted within the short-term time period, comprises determining a baseline estimated probability that the offer value will be accepted within the short-term time period.

In some implementations, the method further comprises generating, using the baseline estimated probability and at least some of the predictive demand features for the first unit at the current offer value, associated sets of predictive demand features for the first unit at the plurality of offer values.

In some implementations, the method further comprises determining, using the associated set of predictive demand features for the first unit at the plurality of offer values, the set of associated estimated probabilities that each offer value will be accepted for the first unit within the short-term time period.

In some implementations, the expected time-to-acceptance for the first unit at each of the plurality of offer values is determined using the set of associated estimated probabilities.

In some implementations, the baseline estimated probability and the set of associated estimated probabilities are determined by a short-term lease predictor.

In some implementations, the method further comprises, prior to determining, for the first unit at each of the plurality of offer values, the set of associated estimated probabilities that the offer value will be accepted within the short-term time period: training the short-term lease predictor based on a training set, the training set including historical data for a plurality of units.

In some implementations, the baseline estimated probability is generated using a regression model.

In some implementations, the short-term time period is between 7 days and 21 days.

In some implementations, the method further comprises receiving location feature data for the first unit; and determining, based on the location feature data, a location feature signal; wherein determining, for the first unit at each of a plurality of offer values, a set of associated estimated probabilities that the offer value will be accepted within the short-term time period, is based in part on the location feature signal.

In some implementations, the method further comprises receiving subunit feature data for the first unit; and determining, based on the subunit feature data, a subunit feature signal; wherein determining, for the first unit at each of a plurality of offer values, a set of associated estimated probabilities that the offer value will be accepted within the short-term time period, is based in part on the subunit feature signal.

In some implementations, determining the unit demand signal comprises processing of at least one of a type of gathering page views, email parsing, establishing an application programming interface (API) call to a third-party webpage or event logging.

According to the subject matter of the present application, there may be provided a server comprising a communications module; a processor coupled with the communications module; and a memory coupled to the processor and storing processor-executable instructions which, when executed by the processor, configure the processor to receive unit feature data for a first unit; determine, based on the unit feature data, a unit feature signal; receive unit demand data for the first unit at a current offer value; determine, based on the unit demand data, a unit demand signal, the unit demand signal including predictive demand features; determine, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value; determine, based on the set of associated estimated probabilities, an expected time-to-acceptance for the first unit at each of the plurality of offer values; determine an optimal offer value for the first unit using the expected time-to-acceptance for the first unit at the plurality of offer values; and display the optimal offer value for the first unit on a webpage.

In some implementations, the processor is further configured to store the optimal offer value for the first unit; transmit the optimal offer value for the first unit to a unit-owner computing device; and receive an approval response from the unit-owner computing device.

In some implementations, processing the unit feature data includes processing and combining the unit feature data into a unit feature data score.

In some implementations, determining, for the first unit at each of the plurality of offer values, the set of associated estimated probabilities that the offer value will be accepted within the short-term time period, comprises determining a baseline estimated probability that the offer value will be accepted within the short-term time period.

In some implementations, the processor is further configured to generate, using the baseline estimated probability and at least some of the predictive demand features for the first unit at the current offer value, associated sets of predictive demand features for the first unit at the plurality of offer values.

In some implementations, the processor is further configured to determine, using the associated set of predictive demand features for the first unit at the plurality of offer values, the set of associated estimated probabilities that each offer value will be accepted for the first unit within the short-term time period.

In some implementations, the expected time-to-acceptance for the first unit at each of the plurality of offer values is determined using the set of associated estimated probabilities.

In some implementations, the baseline estimated probability and the set of associated estimated probabilities are determined by a short-term lease predictor.

In some implementations, the processor is further configured to, prior to determining, for the first unit at each of the plurality of offer values, the set of associated estimated probabilities that the offer value will be accepted within the short-term time period train the short-term lease predictor based on a training set, the training set including historical data for a plurality of units.

In some implementations, the baseline estimated probability is generated using a regression model.

In some implementations, the short-term time period is between 7 days and 21 days.

In some implementations, the processor is further configured to receive location feature data for the first unit; and determine, based on the location feature data, a location feature signal; wherein determining, for the first unit at each of a plurality of offer values, a set of associated estimated probabilities that the offer value will be accepted within the short-term time period, is based in part on the location feature signal.

In some implementations, the processor is further configured to receive subunit feature data for the first unit; and determine, based on the subunit feature data, a subunit feature signal; wherein determining, for the first unit at each of a plurality of offer values, a set of associated estimated probabilities that the offer value will be accepted within the short-term time period, is based in part on the subunit feature signal.

In some implementations, determining the unit demand signal comprises processing of at least one of a type of gathering page views, email parsing, establishing an application programming interface (API) call to a third-party webpage or event logging.

According to the subject matter of the present application, there may be provided a non-transitory computer readable storage medium comprising computer-executable instructions which, when executed, configure a processor to receive unit feature data for a first unit; determine, based on the unit feature data, a unit feature signal; receive unit demand data for the first unit at a current offer value; determine, based on the unit demand data, a unit demand signal, the unit demand signal including predictive demand features; determine, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value; determine, based on the set of associated estimated probabilities, an expected time-to-sell for the first unit at each of the plurality of offer values; determine an optimal offer value for the first unit using the expected time-to-sell for the first unit at the plurality of offer values; and display the optimal offer value for the first unit on a webpage.

Other aspects and features of the present application will be understood by those of ordinary skill in the art from a review of the following description of examples in conjunction with the accompanying figures.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

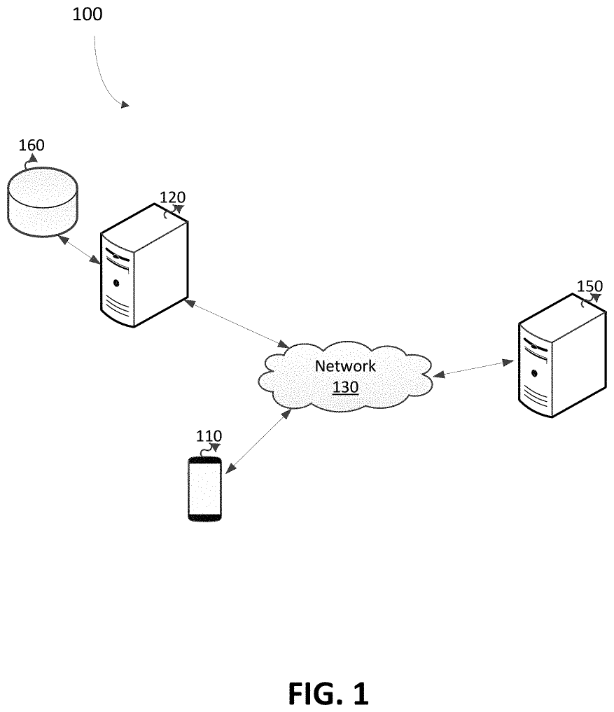

FIG. 1 is a schematic operation diagram illustrating an operating environment of an example embodiment. As shown, the system 100 includes a computing device 110, a server 120, and a database 160 associated with server 120, coupled to one another through a network 130, which may include a public network such as the Internet and/or a private network. The computing device 110 and the server 120 may be in geographically disparate locations. Put differently, the computing device 110 and the server 120 may be located remote from one another.

The server 120 is a computer system.

The computing device 110 may take a variety of forms such as a smartphone, a tablet computer, a wearable computer such as a head-mounted display or smartwatch, a laptop or desktop computer, or a computing device of another type.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The system 100 also includes one or more servers associated with input data, including unit characteristic data and unit demand data. The input data may originate from web server 150, for example. The input data may also reside in database 160, which in some implementations may be internal to server 120 (e.g., disposed within a body of the server 120). Although not shown, the web server 150 may communicate with the server 120 using one or more Application Programming Interfaces (APIs). The server 120 may communicate with the web server 150 through an intermediary.

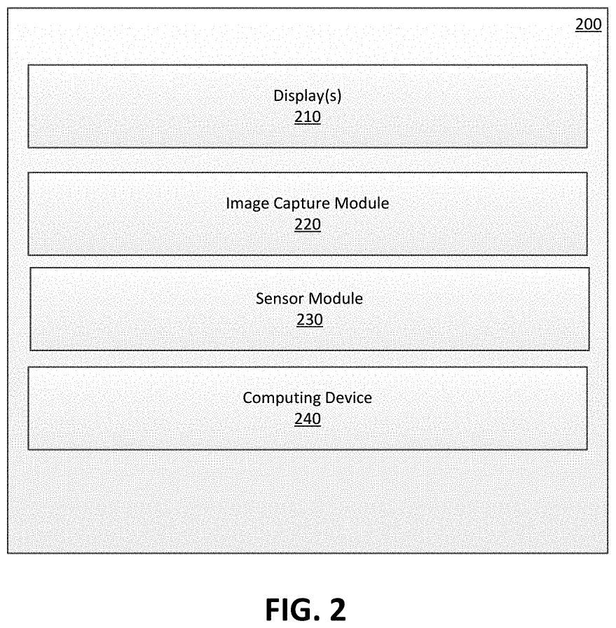

FIG. 2 is a simplified schematic diagram showing components of an exemplary computing device 200. Computing device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

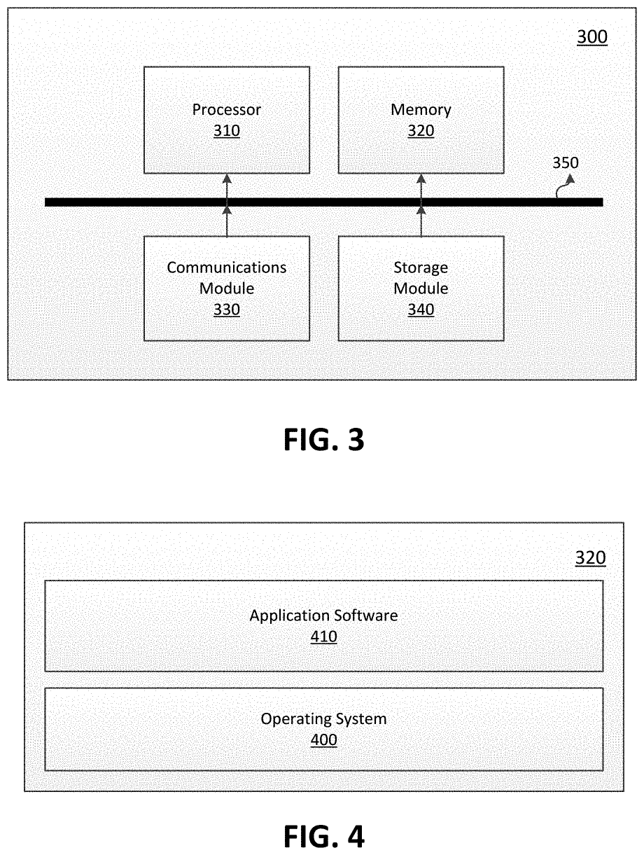

Referring now to FIG. 3, a high-level operation diagram of an example computer device 300 is shown. In some embodiments, the computer device 300 may be exemplary of the computer device 240 (FIG. 2), the application server 120, resource server 140 and/or web server 150.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi (™), using Bluetooth (™) or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persistent storage other than the persistent storage (if any) accessible via the memory 320. In some embodiments, the storage module 340 may be used to store and retrieve data in a database. A database may be stored in persistent storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google (™) Android (™), Apple (™) iOS (™), UNIX (™), Linux (™), Microsoft (™) Windows (™), Apple OSX (™), macOS (™) or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2) and/or the server 120.

While a single application 410 is illustrated in FIG. 3, in operation the memory 320 may include more than one application 410 and different applications 410 may perform different operations. For example, in at least some embodiments in which the computer device 300 is functioning as the computing device 110, the applications 410 may include a real estate management application. The real estate management application may be configured for secure communications with the application server 120 and may provide various real estate management functions such as, for example, the ability to receive and to approve offer values.

When a user wishes to access (for example, to approve or reject an offer value) a real estate management application resident on the computing device 110, the user may utilize an input interface (such as a keyboard and/or touchscreen) associated with the computing device 110 to cause the computing device 110 to open a real estate management application. Touch gestures, for example, may be used to select an icon associated with the real estate management application.

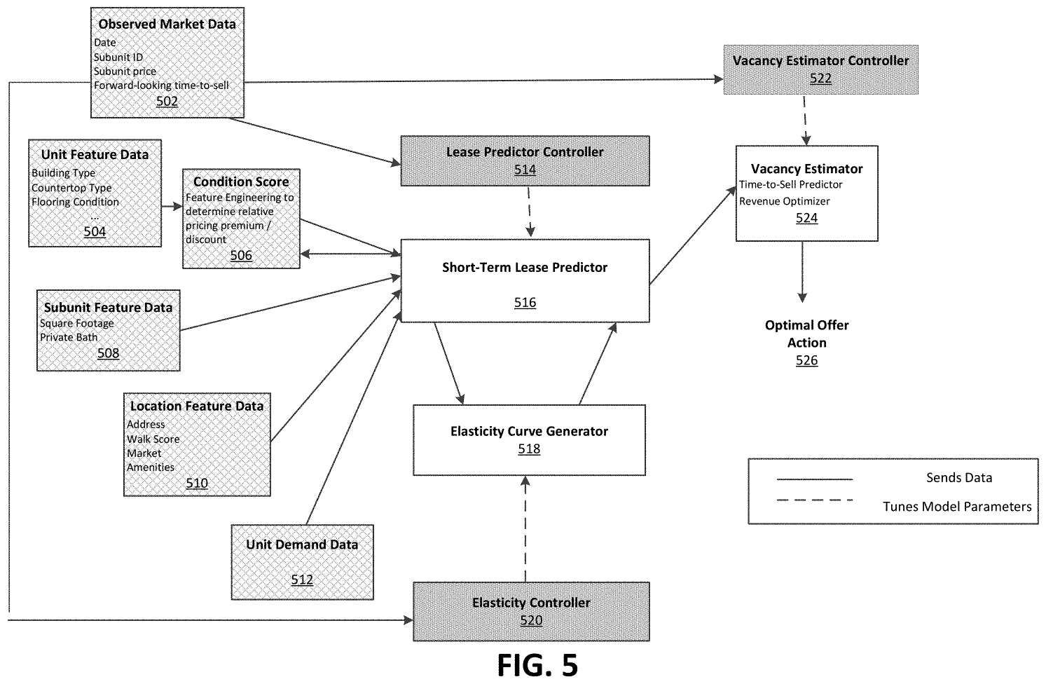

FIG. 5 is a schematic diagram showing a system comprising modules associated with an embodiment of the present application. The cross-hatched modules represent aspects of system inputs and may include the observed market data 502, the unit feature data 504, the condition score 506, the subunit feature data 508, the location feature data 510 and the unit demand data 512. The plain modules may include estimator and predictor functions, and may include the short-term lease predictor 516, the elasticity curve generator 518 and the vacancy estimator 524. The vacancy estimator may output the optimal offer action 526. The darkened modules may indicate computational or control functions and may include the lease predictor controller 514, the elasticity controller 520 and the vacancy estimator controller 522. The schematic diagram of FIG. 5 shows the data flow between these modules. As indicated, solid lines represent data transmission and dotted lines represent the tuning of model parameters.

A unit under analysis, (i.e., a first unit), may contain subunits, meaning that the first unit may have the potential to be partitioned and sold or leased as smaller subunits. In these cases, the associated subunit features may be incorporated into the datasets used.

A unit may be considered to be a subunit if it is part of a larger unit that may be offered for sale or for lease. A subunit may be, for example, a single bedroom.

### Data Acquisition Process

Unit demand data may include a variety of datasets and data sources that describe the units and their associated demand trends over time. These datasets and data sources may be tied to their resultant successful sales to generate a large body of historical data that may be used to train the short-term lease predictor 516.

Unit demand data may be received from proprietary website pages and third-party listing websites that may be used to generate demand for an individual unit. In one embodiment, proprietary website pages and third-party websites may be retrieved by the server 120 from web server 150, via network 130. In one embodiment, through a combination of internally written scripts and third-party tools, data may be acquired through methods including but not limited to: emails received from third-party listing sites to gather user details and the unit the user is interested in; user-unit interaction events on proprietary products through customer data platform integrations; and internal database records of applications, tours, chats and sales team interactions.

A unit demand signal including predictive demand features may be determined based on the unit demand data. These unit demand signals may be augmented by data collected in person or through videos, images or 3D renderings of the features of the units. Videos, images and 3D renderings of the unit may be retrieved by server 120 from database 160, or from internal storage of server 120. Videos, images and 3D renderings of the unit may also be retrieved by server 120 from web server 150 via the network 130. These features can be translated into a calculated feature to increase or decrease the worth of a particular unit compared to other units in the same market.

Various computer driven techniques to gather and receive unit demand features may include email parsing to gather lead information and to attribute the lead information to specific channels and properties; API calls to allow third party sites to pass lead information directly into the system; Uniform Resource Locator (URL) parsing to gather page views; and event logging to allow us gathering of universal starts. The event logging may be performed via a customer data platform (CDP) such as Segment. Information about tours, applications, and leases may be gathered and/or received from a centralized database, such as database 160, and/or from Software as a Service (SaaS) systems.

API calls, email parsing, and URL parsing may be used because the unit demand metrics are not directly accessible to the system. That is, listings of the unit or subunit may be on other sites hosted and operated by third parties. The other sites may be aggregators in some cases, or may be standalone unit listing sites. Accordingly, the measured user interaction data or metrics with those sites may not be available to the short-term lease predictor 516. In some cases, the other sites may provide access such that API calls may be placed to extract or obtain some data regarding user interactions with the other site. In some cases, the data may need to be filtered or parsed to identify useable user interaction metrics reflect of unit demand.

Some examples of predictive demand features comprising a unit demand signal may include:
‘Unit page view average over time period’
   (The daily average number of page views that we received for that unit for a period of time)
‘Unit lead average over time period’
   (The daily average number of leads that we received for that unit for a period of time)
‘Unit universal start average over time period’
   (The daily average number of call to action starts (button clicks) that are received for that unit for a period of time)
‘Unit page view average’
   (Average daily page view count since the unit was listed)
‘Page view trend’
   (How average page views in the most recent 7 days compare to the average in that market since the unit was listed)

The unit feature data 504 includes the major features used to evaluate the first unit, which may be a whole unit or a subunit. These features are directly tied to the offer value under consideration. The unit feature data 504 may include the current price of the first unit, the area of the first unit as typically measured in square feet, the availability of bathrooms, unit price change history and other major factors involved in a leasing or purchase decision by potential tenants or owners.

Unit features represent the different qualities of space, or in some cases, shared space, that a potential tenant may look for, such as the type of flooring, the condition of flooring, the types of appliances, and other features inherent to the unit. These features may be evaluated as a collective condition of the unit. A unit feature signal may be determined based on the unit feature data and may include predictive unit features. Some examples of predictive unit features may include:
‘Building Type’ (for example, the type of property, such as single-family home, condo, townhouse, multi-family unit);
‘Kitchen appliances’ (for example, Stainless steel, plastic);
‘Kitchen countertops’ (for example, Granite, quartz, wood, laminate)
‘Hardware Finish’
‘Is there a dryer?’
‘Is there a washer?’
‘Is there a microwave?’
‘Is there a dishwasher?’
‘Does the unit have A/C?’
‘Does the unit have heating?’
‘Does the unit have a pool?’
‘Does the unit have a backyard?’
‘Does the unit have a patio or balcony?’
‘Bedroom flooring’ (e.g., Carpet, ceramic, hardwood, linoleum)
‘Kitchen flooring’ (e.g., Ceramic, hardwood, linoleum)
‘Living/common space flooring’ (e.g., carpet, ceramic, hardwood, linoleum)
‘Condition of the flooring’ (e.g., Perfect, acceptable, needs work)
‘What year was the home built or last remodeled?’

Minor predictive unit features may be processed and combined together in a single score, to become a major predictive unit feature. A process of feature engineering is performed by the system on these features and reflects the collective condition of the unit. The feature engineering process evaluates the value each feature provides to the overall condition of the unit with decorrelation of features, such as decorrelation of stainless-steel appliances and granite countertops. The resultant unit condition score 506 allows for a comprehensive view of the unique unit-specific features that is useful input to the short-term lease predictor 516.

Subunit feature data 508 describes the parameters, resources and condition of a subunit. A subunit feature signal including predictive subunit features may be determined based on the unit demand data. Some examples of subunit attributes may include:
‘Market listing price’ (e.g., subunit price compared to market average)
‘Subunit listing price’ (e.g., subunit price compared to subunit average)
‘Subunit size’ (e.g., square footage of a room)
‘Market subunit size’ (e.g., subunit size compared to market average)
‘Unit subunit size’ (e.g., subunit size compared to subunit average)
‘Has private bath’
‘Price change—10’ (e.g., how much did the price change in the last 10 days?)

The location feature data 510 may describe geographic features, such as the neighborhood, latitude and longitude, local school, and walkability information. The location feature data 510 may also describe location amenities. A location feature signal which may include predictive location features may be determined based on the location feature data.

The location feature data 510, the subunit feature data 508 and the unit feature data 504 may be retrieved by server 120 from a database 160, or from internal storage of server 120. Additionally or alternatively, the location feature data 510, the subunit feature data 508 and the unit feature data may also be retrieved by server 120 from web server 150 via the network 130.

The observed market data 502 may include information on market trends for other units that were recently sold in the same geographic region. This information may increase the understanding of how a particular unit's features may result in a revenue maximizing offer value. In practice, market trends may allow for the repricing of a unit without prior demand information, such as upon listing it as available, either for the first time as a new unit never previously purchased or a as unit that was previously purchased but has recently become available for purchase. The observed market data may be retrieved by server 120 from database 160, or from internal storage of server 120. The observed market data may also be retrieved by server 120 from web server 150 via the network 130.

The observed market data 502 may include date data (e.g., date of unit availability), price data, and actual and forward-looking (i.e., projected) time-to-sell data. In cases where the first unit may be sold or leased as smaller subunits, the subunit characteristics are incorporated into the datasets used, and the observed market data 502 may also include subunit identification (ID) data and subunit price data.

As illustrated by FIG. 5, the observed market data 502 may provide input data to the three controller modules, the lease predictor controller 514, the elasticity controller 520 and the vacancy estimator controller 522.

The input data may be collated in a centralized database, for example, external database 160 and/or a database internal to server 120. As previously described, unit demand signal including predictive demand features may be determined based on the unit demand data. For example, in the database, the data may be cleaned and rolled up into datasets representing a combination of features. In one implementation, an example of such a dataset may be a count of events-by-type per-unit per-date dataset. These datasets may include all major events in generating demand for the unit and may be used to evaluate the likelihood of generating a sale or a lease on that unit. Unit demand signal data points that may be particularly useful in some implementations may include initial lead interest, page views for a unit, the initial step in the sales process, submission of an application for approval to sign a real estate contract, touring a unit, receipt of a contract for a unit and/or the sale or signed contract for a unit.

Any changes made to marketing the unit may be recorded in tables detailing historical state changes for critical data points. For example, the listing period for available units may have historical tracking that marks the date of changes in the unit's availability. Furthermore, units may be marketed and contracts may be signed while a unit has a current purchaser who will soon move out and will no longer have a signed contract for the unit.

In situations where the features may generate a low signal, the features may be combined from a series of minor features with lower predictive power into a major feature with higher predictive power. This combination may allow for a more accurate algorithm design and simpler interpretability for users.

An objective of the short-term lease predictor 510 may be to provide input to the vacancy estimator 524 to determine the time-to-sell length of a first unit given its current price. Training data may be used to train the short-term lease predictor. Training data may include historical values of units, which may include unit vacancies and unit prices. Using these historical values, a regression model may be built which may provide the predicted future vacancies of new units given their prices.

Training data may not be assumed to be optimal when human decision making has been used to make price adjustments. Outside factors, such as business needs to fill units quickly through discounting, slow or missed opportunities to adjust prices at optimal times, or price adjustments not based on demand, may often lead to erroneous data points. Therefore, the model's training process may include multiple features engineered to accommodate these and any other observed deficiencies in the training data.

As a result, final time-to-sell may be constructed as the function of market condition, seasonality and all price changes that are experienced during the time-to-sell period. The short-term lease predictor may isolate the effects of any additional price changes in order to determine how each price affects demand.

In some implementations, the system may attempt to determine a time-to-sell directly from the input data and one or more models; however, it has been discovered that the modeling does not perform well in directly determining time-to-sell. This may be in part due to the fact that training data that spans a longer time period may incorporate within it one or more price changes, which have significant impacts on the modeling. Unexpectedly, it has been determined that the computer system is capable of providing significantly more accurate predictions of time-to-sell in a more efficient manner, if the system is trained to first determine a short-term lease probability and then, based on that short-term lease probability, to determine a time-to-sell prediction (e.g. a vacancy time estimation) as a part of determining an optimal offer value that maximizes the balance of revenue versus vacant time before sale or lease.

In line with this goal, in accordance with one embodiment of the present application, a method to determine the probability that a first unit at a given price is going to be filled in a fixed period of time is provided. The fixed period of time may be 14 days, but other values, such as 7 days, 10 days, 21 days or 28 days may be used. Short period market conditions may be assumed static and a single change to price may be performed. The output of this model component may be a probability value for a sale or lease to be generated in the short-term interval.

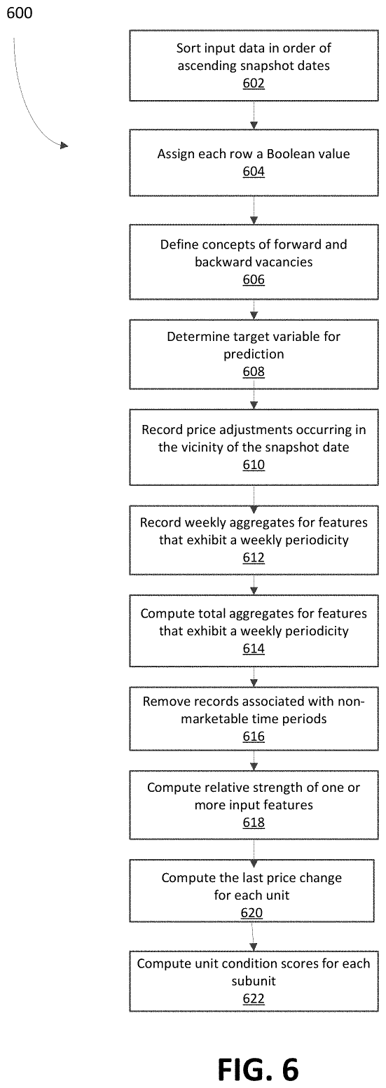

The operation of the example method 600 in training the short-term lease predictor 516 will now be described with reference to a flowchart 600 of FIG. 6.

At 602, the application server 120 sorts the input data so that the rows that belonging to the same subunit are sorted in order of ascending snapshot dates and to ensure that for each subunit every snapshot date is unique. In one implementation, this may be performed by omitting duplicate rows with the same subunit id and snapshot date. After this step, the (subunit id, snapshot date) may serve as a unique key in the input data.

At 604, the application server 120 assigns a Boolean value to each row identified by the (subunit id, snapshot date). The Boolean value indicates whether the unit was marketable on that date.

At 606, the application server 120 defines the concepts of forward and backward time-to-sell. For each marketable subunit and snapshot date:
If the subunit is not marketable that day, then the forward time-to-sell is 0;
If the subunit is marketable:
   if it is the latest day, then the forward time-to-sell is not yet known, so it is set to None;
   if it is not the latest day,
      if the forward time-to-sell of the next snapshot is None, then forward time-to-sell is set to None;
      otherwise, the forward time-to-sell is set to the forward time-to-sell of the next snapshot plus the positive time difference of the two snapshots.

Backward time-to-sell is the opposite of forward time-to-sell. Backward time-to-sell counts the number of days since the subunit became marketable. For each subsequent record ordered by the snapshot date, for each subunit, the backward time-to-sell increases by the difference between the two snapshot dates, and the forward time-to-sell decreases by the same number. The sum of the forward time-to-sell and the backward time-to-sell stays constant, and together they define the length of the marketable period.

At 608, the application server 120 determines a target variable for prediction. The target variable may indicate, for each of the (subunit id, snapshot date) records, whether the respective unit will receive a lease within the next short-term period; in other words, whether the unit's forward time-to-sell on that date is not longer than the length of the short-term period.

At 610, for each unit represented by a (subunit id, snapshot date), the application server 120 records price adjustments which occurred in the vicinity of the snapshot date. A price change list of time offsets may be defined, which in one implementation may be [−30 days, −10 days, +10 days, +30 days, +infinite days]. An iteration may then be performed through all day offsets in this price change list. If a subunit is marketable a certain number of days in the past or the future, the ratio of that past or future price and the price on the snapshot date may be recorded. If the subunit is filled a certain number of days in the past or the future, the ratio of the last marketable price and the price on the snapshot date may be recorded.

At 612, the application server 120 records weekly aggregates for features that exhibit a weekly periodicity. In some implementations, these features may be the page view counts, lead counts and/or universal start counts. A weekly average, rather than a weekly sum, may be computed to provide for direct comparison to the total aggregates computed at 614.

At 614, the application server 120 computes the total aggregates for features for features that exhibit a weekly periodicity. A total aggregate is the daily average of the feature since the first non-zero occurrence of that feature. Units may start with a marketable period when they are not yet advertised, so their demand features may be zero for a long time. This process may ensure the non-advertised period does not affect the average once the unit is on the market. As the weekly averages may be quickly self-correcting, they may not require a similar process.

At 616, the application server 120 removes the (subunit id, snapshot date) records from the training data for time periods within which the unit was not marketable.

At 618, the application server 120 computes the relative strength of one or more input features compared to a larger group of units. The units of the larger group may be considered to be relevant to the unit identified by the (subunit id, snapshot id).
In one implementation, the market listing price as the ratio of the unit price to the average unit price in the same market is computed.
In one implementation, the subunit listing price as the ratio of the subunit price to the average subunit price in the same unit is computed.
In one implementation, the market unit size as the ratio of the unit size to the average unit size in the same market is computed.
In one implementation, the unit's subunit size as the ratio of the subunit size to the average subunit size in the same unit is computed.

At 620, the application server 120 computes the last price change for each of the (subunit id, snapshot date) pairs. The last price change may be the ratio of the current price and the previous price that the unit was advertised for, and the last price run, which is the number of days since the current price was in effect. If there is no previous price change for the unit, then the last price change is taken to be 1.

At 622, for each subunit id, the application server 120 computes the unit condition scores from the unit features of the unit that the subunit resides in. This process will be described in detail in the next section.

### Computing the Unit Condition Scores

The unit condition scores are determined by feature-value pairs associated with the unit. In some implementations, the list of features used in these pairs may be all of some of the features listed above. The value in these pairs is the value of the associated feature in that unit. For example, in one application, the feature “Kitchen Countertops” may have the possible values “granite”, “quartz”, “laminate”, “wood”, and “other”. The appropriate feature value may be selected for the unit. The unit is then described by such feature-value pairs, for example “Building type: condo”, “Kitchen appliances: stainless steel”, “Kitchen countertops: granite”, “Balcony: yes”, “Common space flooring: ceramic or porcelain tile,” etc.

The first part of determining the unit condition scores is computing the price adjustment for each feature-value pair. The historic market listing prices, as defined above at 618, may be used for this purpose. The price adjustment PA(F, V) of a feature-value pair (F, V) is the average market listing price of all properties whose feature takes that value. For example, the price adjustment PA(“Common space flooring”, “ceramic or porcelain tile”)=1.091 means that properties that have ceramic or porcelain flooring in their common space sell or lease at a price that is 9.1% higher than an average unit in their market. The price adjustment PA(“Dishwasher”, “no”)=0.960 means that properties without dishwashers sell or lease at a price that is 4% lower than average.

The price adjustments are not additive. For example, kitchens with stainless steel appliances are likely higher-grade overall, and therefore more likely to have granite countertops. As a result, factoring in the price adjustment for “Kitchen appliances: stainless steel” would factor in some parts of the price adjustment associated with “Kitchen countertops: granite”. Similarly, properties that do not have washing machines often do not have dryers, so once the discount for no washing machine is factored into the price, the discounted price may contain all or part of the discount for no dryer.

In some implementations, the system may be configured to produce an additive set of feature-value price adjustments, wherein these adjustments are decorrelated and can be added together. In one implementation, the method described below may be used to compute the individual contribution of feature-value pairs.

The Shannon entropy gives the average code length per symbol in a sequence as:

(H(X)=−Σₖpₖ log(pₖ))

The joint entropy H(Y; X) of two sources Y and X is the entropy of the source composed of pairs taken from Y and X The conditional entropy:

H(Y|X)=H(Y;X)−H(X)

gives the average amount of information in Y not present in X. A feature is represented by the set of values it may assume, and the empirical probability of each value is computed for that feature. The empirical probability is the number of times of that feature-value pair, divided by the total number of times the feature is provided in the training data. In this way, for two features F₁ and F₂, the unaccounted price between F₁ and F₂ is defined as:

$$UP ( {F}_{1} , {F}_{2} ) = \frac{H ( {F}_{2} \vert {F}_{1} )}{H ( {F}_{2} )}$$

This formula represents the proportion in the price of F₂ not explained by F₁.

The computation of the condition score and the corresponding unit price adjustment may use a set PR which contains the features already taken into account for the score. Initially the unit price adjustment is 1 and the set PR is empty. Features are added to the computation one after the other as they are processed. In each cycle, it is determined, for the unit, which feature-value pair (F_{c}, V_{c}) most commonly occurs in the portfolio. Then the feature Fₚ∈PR is identified that has the lowest unaccounted price UP(Fₚ, F_{c}) with F_{c}. Next, the unit price adjustment is multiplied by:

exp(UP(Fₚ,F_{c})×log(PA(F_{c},V_{c}))),

and F_{c} is added to PR. This process may be then repeated until PR contains all features specified for the unit.

At the end of this process, the value of the unit price adjustment indicates how much the unit price differs from the average unit price on account of its unit features. For example, if the unit price adjustment is 1.12, then the unit should be 12% more expensive than the average unit in its market. The unit condition score is the ratio of the number of all units whose price adjustment is lower than the current unit, and the number of all units. For example, if the number of units in the market is 200 and 160 of them have a price adjustment lower than 1.12, then the condition score for a unit with price adjustment 1.12 is 0.8.

### Usage of the Short-Term Lease Predictor

The system used for predicting the probability of the short-term lease from the predictive features may incorporate any binary classification algorithm which additionally provides estimates for the probabilities of the binary outcomes. Examples include, but are not limited to random forests, gradient boosting, neural networks and logistic regression. The parameters of the model depend on the number of predictive features and the size of the training data. In one application, the predictive features may be restricted to “Market listing price”, “Market subunit size”, “Has private bath”, “Unit page view average of time period”, “Unit lead average over time period”, “Unit universal start average over time period”, “Unit page view average” and “Page view trend”, together with a gradient boosting classifier with 50 trees, limiting each tree to a maximum depth of 3. In another application, a larger number of predictive features may be used, for example: “Unit page view average over time period”, “Unit lead average over time period, “Unit universal start average over time period”, “Unit page view average”, “Page view trend”, “Market listing price”, “Subunit listing price”, “Subunit size”, “Market subunit size”, “Unit subunit size”, “Has private bath”, “Price change −10” and “Unit condition score”, together with a gradient boosting classifier with 150 trees, limiting each tree to a maximum depth of 4. These parameters may be used with training data that has between 100,000 and 1,000,000 samples in it. For larger training data, the application may be refined by increasing the number of trees in the gradient boosting classifier.

Preparing the model from the training sample and then using the model and the predictive features to form a new short-term lease prediction works as defined by the appropriate binary classification algorithm. The output of this process for each set of input features Fₖ is a value pₖ∈[0, 1], where higher values indicate a higher probability of lease or sale success. Note that the pₖ values may not represent probabilities, especially for classifiers that use some form of sigmoid scores in their output. For example, pₖ=0.2 may not be equal a 20% chance of success. Note also that two feature sets k and l with pₖ=0.2 and Pₗ=0.4 may not indicate that lease l is twice as likely to happen as lease k. What this information may indicate is that lease l is more likely to occur than lease k. As a result, in one application a post-processor is applied in the form of a function:

ƒ: [0,1]→>[0,1]

to tune the output of the classifier as needed. The function ƒ is a monotonic, increasing function. This function is applied to the output pₖ of the binary classifier, resulting in the final output ƒ(pₖ) which may be construed as the probability of the short-term lease for the given predictive features. In some embodiments, isotonic regression may be used in this process.

Elasticity curve generator 518 performs two main functions: price elasticity prediction and price elasticity curve construction.

### Price Elasticity Prediction

The price elasticity predictor of the elasticity curve generator 518 involves an estimation of the effect of price changes on demand features. For example, if it known that at price P a subunit on a given day sees V page views, L leads and S call to action starts, then how many page views V′, leads L′ and call to action starts S′ may be expected to be seen at a different price P′? In one implementation this may be determined by determining a mapping of the form

EC(P′/P,V,L,S)→(V′,L′,S′)

where P′/P, the ratio of the new price and the old price, is considered the pricing action theoretically taken.

In general, the mapping EC may also be influenced by other factors. Examples include the estimated probability that the subunit is going to have a short-term lease C, the market M, and the seasonality affecting demand T.

The feature C is derived in the initial step in the short-term lease predictor as a baseline. This feature is used to provide the initial estimate because the same absolute or relative price change has been observed to have different reactions for units that have a high initial likelihood to be leased or sold versus those that initially have a low likelihood to be leased or sold. For example, if the short-term lease probability of a subunit is only 5%, it has been shown to be relatively easy to double the probability to fill the subunit with a price discount. If the short-term lease probability is 40%, doubling the probability requires a much greater price discount which may cause significantly lower annual revenue.

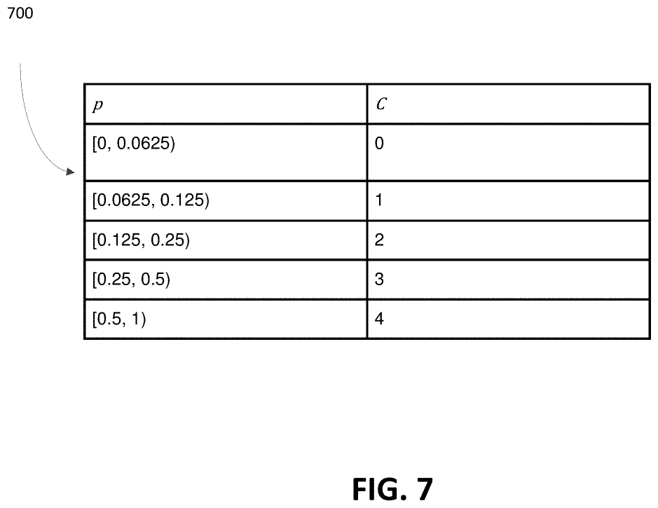

In some applications, a simplification of the probability may be used to allow the price elasticity predictor to use an abstraction of probability. In these applications, probability classes may be defined based on the short-term lease probabilities of units, and the class C index may be used as an input feature to the elasticity prediction. In one implementation, the definition of this index C based on the short-term lease probability p given in the previous section is illustrated by FIG. 7.

FIG. 7 illustrates a two-column table 700 having a first column p (probability) and a second column C (Class Index). In the drawing, there are five corresponding (p, C) value pairs as follows: [(0, 0.062500, 0]; [(0.0625, 0.125), 1]; [0.125, 0.25), 2]; [(0.25, 0.5), 3]; [(0.5, 1), 4].

The features in the variable M measure demand response in a geographical region, assuming a uniform response to price changes across that geographic region. For example, M can be a neighborhood, a city, a metropolitan area or any geographic area in which similar market dynamics exist. Sufficient training information is required for deriving the curves in their designated markets. In the absence of sufficient historic price changes to compute stable elasticity curves in a given market, one of multiple options may be used to augment the data. For example, combining the market with other, similar markets and merging the market into other, larger markets, even when these markets are not geographically connected. For example, in one implementation, the following, dedicated M index values may be used: 0 for Brooklyn and New York City; 1 for all other boroughs in New York City; 2 for Los Angeles; 3 for Chicago, 4 for all cities in and around the Bay Area; and 5 for all other cities in the continental United States.

The features in the variable T measure demand response in a time period in which it may be assumed the response is the same as it is at the time when the system is used to predict new time-to-sell periods. For example, interest for units in the summer may be much higher than in the winter. These variations result in different market responses for the same price change. The value T describes the historical time period which we consider to be relevant to the present time. In one implementation, this could be the most recent 50 days. If there are not enough price changes in the training data in a certain time interval with which to form meaningful elasticity curves, the time limit may be extended to include more training data, rather than including training data from seasons of different market behavior. Historically comparable time periods may also be used to account for seasonality, such as the same time period from the previous year.

One implementation of the price elasticity prediction may take any or all of the above factors into account, resulting in a mapping of the form:

EC(P′/P, C, M, T, V, L, S)→(V′, L′, S′)

### Price Elasticity Curve Construction

The price elasticity curve constructor of the elasticity curve generator 518 may use data which shows the history of marketable subunits. The data may include the following fields:
Unit index: separates information for different units
Date: used to derive the T feature
Location/Address: used to determine the M feature
Short-term lease probability: used to determine the C feature
Daily average of page view counts for the past 7 days (feature V)
Daily average of lead counts for the past 7 days (feature L)
Daily average of call-to-action start counts for the past 7 days (feature)
Indicator value showing whether the unit will be leased within the next 14 days

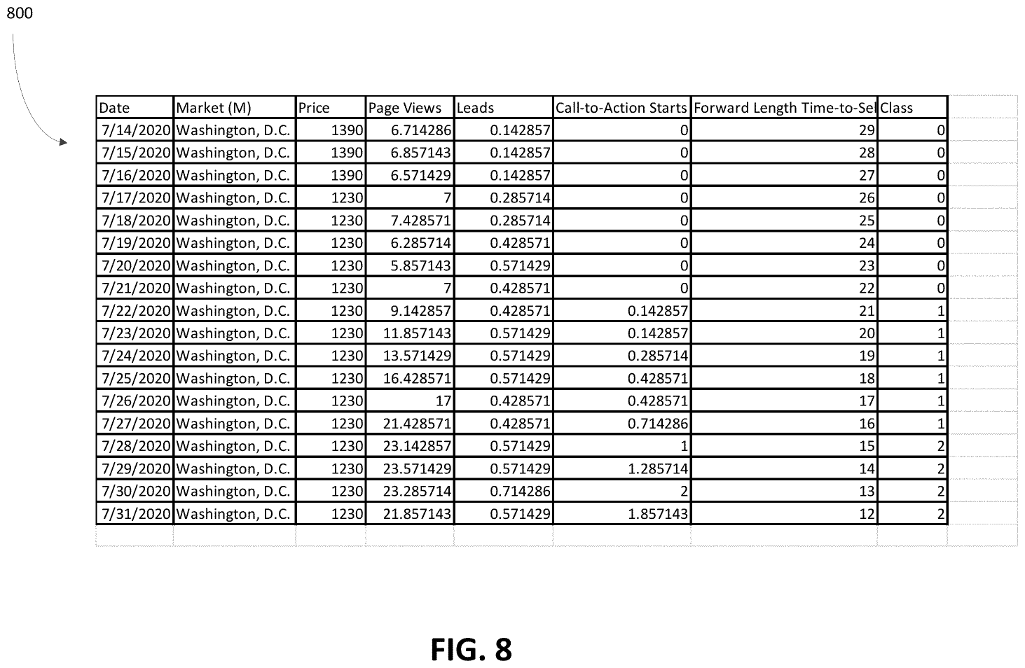

FIG. 8 shows an example of this data in chart 800. As shown in chart 800, M describes the market, which is Washington DC, and T describes the training time period, which is set to include July 2020.

In this example, the unit available to rent is a subunit in Washington D.C. and is marketed for $1390.00 The unit saw an average of 7 page views per day for the last 7 days, and an average of 0.14 leads, which means there was 1 lead sometime in the previous week. On July 17, the price was reduced to $1230.00. A week later, once the moving window for the average daily count was fully after the price change, the average page views doubled, and call-to-action starts have begun. All observed variables continued to increase in the following days.

In some implementations, the signal strength immediately before a price adjustment is compared to the signal strength in a time period after the price change. In one implementation, a number of days may be fixed for each demand variable, for example, page views, leads and call-to-action starts, reflecting the response time of that variable after a pricing action. In one implementation, this can be 10 days for page views, 12 days for leads and 15 days for call-to-action starts. In another implementation a constant 10 days may be used for each feature to measure the effect of the price change after ten days. In another implementation these values may be computed dynamically for each feature by looking for the time offset dt after a price change at date t, which maximizes the feature count in a fixed size window, which may be the lesser of 30 days, or the time till the next pricing action. That is, in this window, which starts at t marking the current pricing action and ends before the next pricing action, the feature took its maximum at time t+dt. The response time of the feature is then taken to be the average of all dt values for all pricing actions in the history.

Once the time offset is established for each feature, the ratios of the feature values at the time offset to the feature values a day before the pricing action are collected. The values before the pricing action, which form the denominator in the ratio, may be 0. As a result, in one implementation we may discard the undefined data points. Alternatively, in another implementation, a smoothing filter may be used as follows: If the feature is an average count over d days, then 1/d is added to both the numerator and the denominator.

The ratios computed this way become the training data for the elasticity curves. For example, chart 800 of FIG. 8 indicates a price change on July 17. Assuming an offset of a fixed 10 days for all features, the values measured 10 days after the price change, July 27, i.e., are compared to those a day before the price change, i.e., July 16. After the undefined data points are discarded, the following ratios may be calculated:

$$\frac{21.43}{6.57} = 3.263 for page views ,$$

$$\frac{0.43}{0.14} = 3. for leads ,$$

and
nothing for call-to-action start counts.

Alternatively, using the smoothing formula, the following ratios may be computed:

$$\frac{21.43 + 1 / 7}{6.57 + 1 / 7} = 3.21 for page views ,$$

$$\frac{0.43 + 1 / 7}{0.14 + 1 / 7} = 2. for leads , and$$

$$\frac{0.71 + 1 / 7}{1 / 7} = 6. for call - to - action start counts .$$

These ratios may form the training data for the given market M (Washington DC), given time period T (includes July 2020), subunit class C (0 at the time of the pricing action on July 17), and pricing action described by the ratio of the new price and old price

$$( \frac{\$1230 \text{.00}}{\$1390 \text{.00}} = 0.88 ) .$$

After the feature ratios as a result of pricing actions are added to the training data, they may be processed before modeling. In one implementation, the processing may identify and remove outlier xₖ/yₖ values from the data. In one implementation, the range of xₖ values may be confined to the interval [0.7, 1.1]. In the same, or in another implementation, the range of yₖ values may be confined to values from 1 to 20 in the [0.7, 0.8] interval, values from 1 to 10 in the [0.8, 0.9] interval, values from 1 to 5 in the [0.9, 1.0] interval and values from 0.5 to 1 in the [1.0, 1.1] interval. All other (xₖ,yₖ) pairs may be omitted. In another implementation, the (xₖ, yₖ) pairs may be constrained such that the yₖ values belong to the two middle quartiles of all yₖ values in their respective range. That is, any (xₖ, yₖ) pairs where yₖ falls in either the first or the fourth quartile of all yₖ values in the section specified by xₖ are omitted. In another implementation, the xₖ values may be pooled based on their first two significant decimal points. For example, by combining all xₖ's from 0.85000 and 0.85999 together, then computing the average of all yₖ values of these pairs, and then replacing all such pairs with a single pair formed by the base xₖ, which in our example is 0.85, and the average yₖ. The output format of this step is the same as that of the previous step, (a sequence of pairs (xₖ, yₖ) where xₖ corresponds to the pricing action and yₖ to the demand change), but the number of pairs and their values may be different, often significantly smaller. This step may filter out many forms of anomalies from the training data.

Once the feature ratios have been cleaned, the elasticity curves of the form:

EC(P′/P,C,M,T,V,L,S, . . . )→(V′,L′,S′, . . . )

may be determined. In one implementation, this determination may be regarded as a regression problem and may be solved using a supervised learning algorithm. In such cases, it may be desirable to prevent noise remaining in the training data from introducing anomalies into the output. An expectation of the output may be that a larger price discount, resulting in a lower P′/P value, consistently leads to higher demand activity. This expected market behavior may be ensured by a post-processing method.

### Postprocessing Method

In some implementations, the supervised learning algorithm may not be used, and a post-processor may be applied directly on the training data. In one implementation, the post-processor may be isotonic regression applied individually to each feature. The input to the isotonic regression is a sequence of pairs (xₖ, yₖ), . . . , (xₖ, yₖ), where the x values are the pricing actions selected by the appropriate C, M and T features, and the y values are the changes in the feature described above.

Applying the above-described feature ratio computation to the example of FIG. 8, chart 800 describes a unit having (0.88, 3.21) for page views, (0.88, 2.00) for leads and (0.88, 6.00) for call-to-action start counts, using class 0 for subunit type, DC for market type and July 2020 for the time frame. When constructing a curve for a class other than 0, or for a market other than DC, or for a month other than July 2020, these data points would not be included among the input (xₖ, yₖ) values for the specific features. The output of the isotonic regression is a sequence of pairs (x₁, y₁), . . . , (x_{N}, y_{N}) , where the xₖ values are monotone increasing and equidistant: x₁<x₂< . . . x_{N} and xₖ+1−xₖ is constant, and the yₖ values are monotone non-increasing: y₁≥y₂≥y_{N}.

This output fulfills the expectation of consistent demand response, although in practice a stepwise function is observed which concentrates all pricing actions into a few candidates. If two pricing actions p₁ and p₂ with p₁<p₂ result in the same demand activity, p₂ will always be preferred to p₁. But, the same demand activity is the result of the isotonic regression rather than a meaningful observation, and these anomalies are eliminated in favor of smoother pricing actions. A frequently used method is the Savitzky-Golay filter, but this filter may not be desirable in embodiments of the present application, as it may break the target constraint y₁≥y₂≥ . . . y_{N}. In one application, a rolling window of a certain size may be applied to the yₖ values, wherein each yₖ is replaced with the average values in the window which is adjusted to yₖ at its center. In another application, the (xₖ, yₖ) pairs at this step with the isotonic constraint applied may be used, then any pair (xₖ, yₖ) such that

(yₖ−yₖ₊₁)×(xₖ₋₁−xₖ₊₁)=(yₖ₋₁−yₖ₊₁)×(xₖ−xₖ₊₁)

may be omitted, then spline regression may be applied to the remaining pairs using the xₖ values as knots, for instance, cubic splines with continuous order-1 and order-2 derivatives at the knots. The result of this step is another sequence of pairs (xₖ, yₖ) , where the constraints x₁<x₂< . . . x_{N} and y₁≥y₂≥ . . . y_{N} are maintained, but with more refined xₖ values and more smoothly changing yₖ values. A sequence of such (xₖ, yₖ) pairs may be called an elasticity curve. One elasticity curve may be created for each (C, M, T, F) vector where C is the subunit class (0, 1, 2, 3, 4), M is the geographic region and economics experienced in that region, T is a timeframe which is relevant to our current market, and F is the demand feature (page views, leads, call-to-action starts, . . . ).

The input to the Elasticity curve generator 518 includes the price change P′/P, class C, market M, and demand signal (V, L, S, . . . ) of the given unit. Each curve has the form:

EC(P′/P,C,M,T,F)→F′

which shows how much a demand feature F changes for a class C subunit in market M and timeframe T when the price of the given subunit is changed from P to P′. Candidate price points around P may be determined. In one implementation, these price points can be the prices in the
[0.7P,1.1P] interval, at increments of 10 dollars. Subsequently, the estimated demand feature F′ for each candidate price P′ and demand feature F as

F′=EC(P′/P,C,M,T,F)

may be determined. The output of this step is the sequence of values (P′, C, M, V, L′, S′, . . . ) for all P′ candidate prices around P. These values may then be augmented by one or more other features of the unit and sent back to the short-term lease predictor 516, so that the short-term lease predictor 516 can generate the probability of a lease in the short-term period for each candidate price P′. In this way, for the first unit at each of a plurality of offer values, a set of associated estimated probabilities that the offer value will be accepted within a short-termtime period may be determined. In some implementations, the short-term time period may be between 7-21 days. In some implementations, the short-term time period may between between 7-14 days. The set of associated estimated probabilities may comprise an associated estimated probability for each offer value.

### Vacancy Estimator

The vacancy estimator 524 may include two parts: a time-to-sell predictor and a revenue optimizer. The purpose of the time-to-sell predictor is to determine the estimated days of time-to-sell from the estimated short-term lease probabilities of a given unit or subunit at varying price points. The input to the time-to-sell predictor 524 is a sequence of pairs (r₁, p₁), . . . , (rₙ,pₙ), where pₖ is the probability of the unit getting leased in the short term at rent rₖ. This input is supplied by the short-term lease predictor 516 using the elasticity curve estimates provided by the elasticity curve generator 518. Since the short-term lease predictor 516 is a point estimator, it does not ensure that the (r₁, p₁), . . . , (rₙ, pₙ) sequence is consistent, meaning that a higher rent is associated with a lower probability. Since the input data may contain a wide range of anomalies that manifest in low-demand units which sometimes lease sooner, and/or high-demand units which sometimes lease later, it may be possible that the elasticity demand estimate at a given price falls close to one of these anomalies. In such scenarios, the short-term lease predictor 516 may pick up the anomaly without trying to reconcile it with neighboring samples. Nevertheless, the time-to-sell predictor of the vacancy estimator 524 may require a consistent input.

To achieve a consistent input, one implementation may apply the same kind of isotonic regression that may have been used for the price elasticity predictor, with one exception: the number and the rₖ values of the pairs may not change; only the pₖ values may be modified. This may, for example, be achieved by isotonic regression. In such scenarios, the input to the isotonic regression may be the sequence of pairs (r₁, p₁), . . . , (rₙ, pₙ), where the r values are the rental prices arranged in increasing order, and the p values are the estimated short-term lease probabilities at the given price. The output of the isotonic regression may be a sequence of pairs (r₁, p₁), . . . , (rₙ, pₙ) where the rₖ values are the same as before, and the qₖ values are monotone non-increasing: q₁≥q₂≥ . . . ≥q_{N}. As with the elasticity curves, a rolling window of a certain size may be applied to the qₖ values, where each qₖ is replaced with the average values in the window which is adjusted to qₖ at its center. In another application, the (rₖ, qₖ) pairs at this step with the isotonic constraint applied may be used, then any pair (rₖ, qₖ) such that

(qₖ−qₖ₊₁)×(rₖ₋₁−rₖ₊₁)=(qₖ₋₁−qₖ₊₁)×(rₖ−rₖ₊₁)

may be omitted, then spline regression may be applied to the remaining pairs using the rₖ values as knots, for instance cubic splines with continuous order-1 and order-2 erivatives at the knots. Next, for each rₖ in the original sequence r₁, . . . rₙ the value of the spline at the given point are assigned to result in the new, smoother probability estimates (r₁, q₁), . . . , (rₙ, qₙ). Intuitively, decreasing, rather than non-increasing probabilities for an increasing sequence of rental prices, may be expected. However, this may not usually be guaranteed by the isotonic regression. If a rolling window and/or spline smoothing is then applied, this constraint may improve to a certain extent, although there may still remain two different prices with the same estimated short-term lease probability. In such situations, the higher price may be favored to the lower price in the revenue optimizer.

After it has been ensured that the sequence of prices is increasing and the associated probabilities are non-increasing, we may compute the estimated days of time-to-sell v for a lease probability p in the short-term lease period of d days as follows. A calendar year may be partitioned to non-overlapping sequences of d-day terms. For each term k in each year in the historical portfolio the number m(k) of marketable units at the beginning of that term is computed, as is the number n(k) of units which among the marketable units at the beginning of that term had a lease by the end of the term. The probability weight w(k) for term k is then computed; where w(k) is the average of n(k)/m(k) over each year in the portfolio. A higher w(k) implies that units have a higher chance of leasing around that time of the year. This may be due to seasonal effects, but also may be due to occasional pricing actions around that time. To eliminate the latter, those units which had a pricing action shortly before or during the term may be excluded from these computations. The estimated time-to-sell is then computed as:

v=d(p+(1−p)(2ƒₖ₊₁(p)+(1−ƒₖ₊₁(p))(3ƒₖ₊₂(p)+(1−ƒₖ₊₂(p)(4ƒₖ₊₃(p)+(1−ƒₖ₊₃(p)(5ƒₖ₊₄(p)+ . . . ))))) (1)

where

$${f}_{t} ( p ) = 1 - exp ( \frac{w ( t )}{w ( k )} log ( 1 - p ) ) \qquad ( 2 )$$

With respect to equation 1, above, it may be practical to use only the first 10-20 terms of the series.

A special case of this method may occur when seasonal weights are not used, for example, when there is not enough training data to establish a periodic market demand. In that case, w(k) may be set to equal 1 for all of the terms, and equations (1) and (2) simplify to v=d/p.

The output of this computation is a sequence of pairs (r₁, v₁), . . . , (rₙ, vₙ), where rₖ is a rental price from the input, arranged in increasing order, and vₖ is the corresponding estimated time-to-sell in days. The vₖ values may be monotonically increasing. The estimated revenue Rₖ from the monthly rent price rₖ and the time-to-sell vₖ measured in days may be calculated as

$${R}_{k} = {r}_{k} \cdot \frac{max ( 365 - {v}_{k} , 0 )}{30} .$$

When both the rental price rₖ and the time-to-sell vₖ are monotonically increasing, then the sequence (r₁, R₁), . . . , (rₙ, Rₙ) is concave with a unique maximum Rₖ. The revenue optimizer finds and returns the price rₖ which determines this maximum revenue Rₖ

It is possible that the resulting (r₁, R), . . . , (rₙ, Rₙ) sequence is not concave, because, for example, the system had many prediction steps which had to operate on noisy data, in spite of the use of the optional smoothing processes. In such, scenarios the resulting (r₁, R₁), . . . , (rₙ, Rₙ) sequence may have more than one local maximum. In one implementation, the highest of these maximums is used. In another implementation, the following computation may be used to compute the number of lower and higher inversions:

For each k in {1, . . . , n}:

L(k)=# of (i,j):i<j≤k and Rᵢ>Rⱼ

H(k)=# of (i,j):k≤i<j and Rⱼ>Rᵢ

The output of the revenue optimizer is the rental price rₖ for index k which minimizes L(k)+H(k). This value may then be implemented as the new price for that unit. In this way, an optimal offer value for the first unit may be determined.

The results of the price changes are monitored and stored as new training material that can be used by feedback controllers to periodically adjust and tune their corresponding model parameters.

### Lease Predictor Controller

The output values pₖ of the binary classifier are further processed by a mapping ƒ to arrive at the final output ƒ(pₖ). The role of the lease predictor controller 514 is to determine this mapping.

In one application, the observed lease events Lₖ are collected for each predicted probability pₖ once the lease events become available at the end of the short-term period after the predictions were made. Denoting a successful lease by 1, and no lease by 0, it may be expected that higher pₖ values have a higher concentration of 1's than lower pₖ values. The mapping ƒ may be constructed such that this will be ensured for ƒ(pₖ). To achieve this, the [0, 1] interval may be split into N consecutive subintervals, and then each observed lease event Lₖ may be associated with the subinterval that contains pₖ. Let C₁(n) be the number of 1's associated with Iₙ, and C₀(n) be the number of 0's associated with Iₙ. Two neighboring sub-intervals Iₙ and Iₙ₊₁ may be selected such that:

C₁(n)·(C₁(n+1)+C₀(n+1))≥C₁(n+1)≥C₁(n+1)·(C₁(n)+Cₒ(n))

and these may be merged into a single interval

C₁(n)+C₁(n+1)1's, and

Cₒ(n)+C₀(n+1)0's.

This process may be repeated until the relation does not hold to any more neighboring subintervals. At this point, epₙ may be defined such that:

$${ep}_{n} = \frac{{C}_{1} ( n )}{{C}_{1} ( n ) + {C}_{0} ( n )} ,$$

which is the empirical probability for the subinterval Iₙ. In one application, the mapping ƒ may be defined as assigning epₙ to each value in Iₙ.

As in the case of the elasticity curves, the mapping ƒ defined this way is monotonic, but it may have a stepwise shape containing overly steep transitions. Therefore, in one application, this function may be processed in the same way as for the elasticity curves, for example, by using either a rolling window or spline regression, to arrive at a smoother approximation of ƒ, which maintains the property of being monotonic.

### Elasticity Controller

The elasticity controller 520 may ensure that the elasticity curves are up-to-date and well adjusted to current market conditions. In one implementation, this may be achieved by periodically reconstructing all of the elasticity curves for the most recent H days available in the training history. The value H itself may be tuned based on the desired responsiveness of the system: larger values of H, that is, more training data, may result in more stable curve construction, but may also merge in market data which is no longer relevant. The value H may therefore be calibrated based on how quickly changes are observed in market conditions. In one application, several candidates H₁<H₂<H₃< . . . may be tried, and the candidate that results in elasticity curves which are the best fit for the most recently observed demand effects after price changes may be chosen.

### Vacancy Estimator Controller

The vacancy estimator controller 522 may periodically adjust the w(k) weights for seasonality prediction, such that each weight is proportional to the best observed short-term lease likelihood in its short-term time period. This process was explained previously in the description of the time-to-sell predictor of the vacancy estimator 524. This process may be carried out periodically by the vacancy estimator controller 522, especially when new training data about observed leases is added to the system.

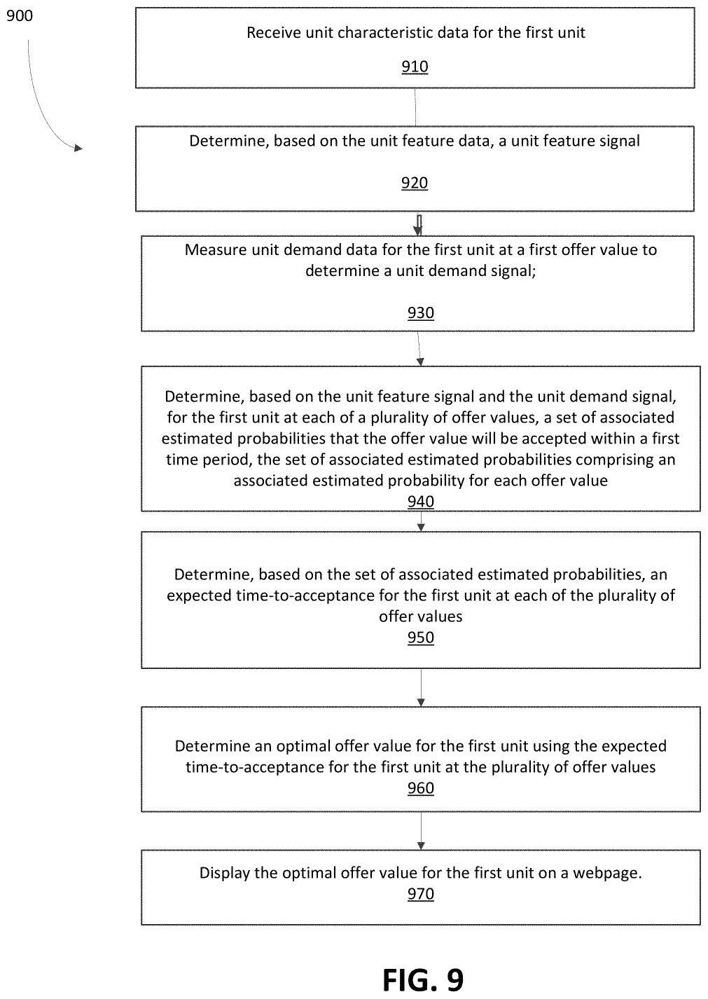

The operation of the example system 900 in determining an optimal offer value for a first unit for display on a webpage will now be described with reference to a flowchart 900 of FIG. 9. FIG. 9 shows operations performed by the application server 120 in real estate management according to an embodiment. The operations may be included in a method 900 which may be performed by the application server 120. For example, computer-executable instructions stored in memory of the application server 120 may, when executed by one or more processors, configure the application server 120 to perform the method 900 or a portion thereof

At step 910, the application server 120 receives unit feature data 504 for the first unit. The unit feature data 504 may be received, for example, from one or more databases internal to server 120 and/or from one or more external databases (e.g., database 160). Additionally or alternatively, the unit feature data may be received, via the communications module and through network 130, from web server 150 and/or from another server. As discussed, unit feature data may describe the resources and features of the unit. The unit feature data 504 may contain subunit feature data.

In some embodiments, as previously described, the application server 120 receives other input data, for example, location feature data such as amenity feature data.

At step 920, the application server 120 determines, based on the unit feature data, a unit feature signal. This determination may include rolling up the unit feature data 504 into a major feature to represent the overall quality of the particular unit, especially the shared spaces when dividing a unit into individual subunits for rent. Unit feature data 504 may also be used independently as they may add value to any predictor, for example, the Short-term lease predictor 516 and/or the Time-to-Sell predictor of Vacancy Estimator 524 and/or the Price Elasticity predictor of the Elasticity controller 520. The individual unit available for rent or lease has a core feature set provided to the predictors to allow for the desired output to be derived, which is the change in offer value that will optimize revenue. In the case of a subunit, the features include but are not limited to the existence of a private bath, the size of the subunit in square feet, any recent price changes or other indicators that may assist in understanding the impact of a price change at a point in time. In the case of a unit, the unit features may take more significance, such as overall square footage, the average square footage per subunit, minimum square footage per subunit, availability of amenities such as a pool or gym, and any other feature that may impact the price.

In some embodiments, when the application server 120 receives other input data, such as location data, an associated feature signal, such as a location feature signal may be determined by the application server 120.

At step 930, the application server 120 measure unit demand data 512 for the first unit at a current offer value to determine a unit demand signal. Unit demand data 512 represents the amount of interest a particular unit is receiving at different stages in the leasing process. Unit demand data 512 may be used at a point in time or may be smoothed in order to give a consistent signal of information despite market volatility or cyclical effects. For example, the number of views for a particular unit or subunit's page may be smoothed out over a 7-day period to remove weekly cyclical effects that may exist within the real estate market. The lifetime average of the unit demand data 512 is also calculated to simplify seasonal effects. Market comparisons are also made by comparing a particular feature for a particular unit to that same feature for all other marketed units at that time.

As a result of demand being generated through third-party websites, the unit demand data 512 may not always represent the particular unit of inventory actually being leased or purchased by a prospective customer. In some implementations, some features may be generated on the associated higher-level unit, for example, features such as generating leads or page views for a unit in which an individual subunit is available for lease or purchase. As a result, the unit demand signals may be created at any available level of granularity for a unit and may then be used by a predictor. In some implementations, the demand signals map directly to the unit available although indirect measurements of demand for the larger unit may be used for predictive purposes.

The unit demand data 504 and the subunit feature data 508 contain many major features, and may be processed, but not combined together. The unit feature data 504 contains many minor features and may be processed and combined together in a single score, which becomes a major feature.

At step 940, application server 120 determines, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value. As previously explained, in some embodiments, this step may include use of the unit feature signal and the unit demand signal by the short-term lease predictor 516 to determine a baseline estimated probability that an offer value will be accepted within a short-term time period. The baseline estimated probability may be generated using a regression model. In some embodiments, this step may further include the generation, by the elasticity curve generator 518, using the baseline estimated probability and at least some of the predictive demand features for the first unit at the current offer value, associated sets of predictive demand features for the first unit at the plurality of offer values. In some embodiments, this step may further include the determination, by the short-term lease predictor 516, using the associated set of predictive demand features for the first unit at the plurality of offer values, the set of associated estimated probabilities that each offer value will be accepted for the first unit within the short-term time period.

At step 950, the vacancy estimator 524 may determine, based on the set of associated estimated probabilities, an expected time-to-sell for the first unit at each of the plurality of offer values. The expected time-to-sell for the first unit at each of the plurality of offer values may be determined using the set of associated estimated probabilities.

At step 960, the vacancy estimator 524 may determine an optimal offer value for the first unit using the expected time-to-sell for the first unit at the plurality of offer values. In this way, an optimal offer value for the first unit may be determined.

At step 970, the optimal offer action 526 may display the optimal offer value for the first unit on a webpage. This step may include storing the optimal offer value for the first unit, transmitting the optimal offer value for the first unit to a unit-owner computing device and receiving an approval response from a unit-owner computing device.

Prior to the implementation of method 900 of FIG. 9, as described with reference to FIG. 6, the short-term lease predictor 516 may be trained based on a training set, and the training set may include historical data for a plurality of units.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A computer-implemented method for determining an optimal offer value for a first unit for display on a webpage, the method comprising:
receiving unit feature data for the first unit;
determining, based on the unit feature data, a unit feature signal;
receiving unit demand data for the first unit at a current offer value;
determining, based on the unit demand data, a unit demand signal, the unit demand signal including predictive demand features;
determining, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value;
determining, based on the set of associated estimated probabilities, an expected time-to-sell for the first unit at each of the plurality of offer values;
determining an optimal offer value for the first unit using the expected time-to-sell for the first unit at the plurality of offer values; and
displaying the optimal offer value for the first unit on the webpage.

2. The computer-implemented method of claim 1, wherein determining, based on the unit feature data, the unit feature signal comprises processing and combining the unit feature data into a single unit feature data score.

3. The computer-implemented method of claim 1, further comprising:
storing the optimal offer value for the first unit;
transmitting the optimal offer value for the first unit to a unit-owner computing device; and
receiving an approval response from the unit-owner computing device.

4. The computer-implemented method of claim 1, wherein determining, for the first unit at each of the plurality of offer values, the set of associated estimated probabilities that the offer value will be accepted within the short-term time period, comprises:
determining a baseline estimated probability that the offer value will be accepted within the short-term time period.

5. The computer-implemented method of claim 4, further comprising:
generating, using the baseline estimated probability and at least some of the predictive demand features for the first unit at the current offer value, associated sets of predictive demand features for the first unit at the plurality of offer values.

6. The computer-implemented method of claim 5, further comprising:
determining, using the associated set of predictive demand features for the first unit at the plurality of offer values, the set of associated estimated probabilities that each offer value will be accepted for the first unit within the short-term time period.

7. The computer-implemented method of claim 6, wherein the expected time-to-sell for the first unit at each of the plurality of offer values is determined using the set of associated estimated probabilities.

8. The computer-implemented method of claim 6, wherein the baseline estimated probability and the set of associated estimated probabilities are determined by a short-term lease predictor.

9. The computer-implemented method of claim 8, further comprising, prior to determining, for the first unit at each of the plurality of offer values, the set of associated estimated probabilities that the offer value will be accepted within the short-term time period:
training the short-term lease predictor based on a training set, the training set including historical data for a plurality of units.

10. The computer-implemented method of claim 4 wherein the baseline estimated probability is generated using a regression model.

11. The computer-implemented method of claim 1, wherein the short-term time period is between 7 days and 21 days.

12. The computer-implemented method of claim 1 further comprising:
receiving location feature data for the first unit; and
determining, based on the location feature data, a location feature signal;
wherein determining, for the first unit at each of a plurality of offer values, a set of associated estimated probabilities that the offer value will be accepted within the short-term time period, is based in part on the location feature signal.

13. The computer-implemented method of claim 1 further comprising:
receiving subunit feature data for the first unit; and
determining, based on the subunit feature data, a subunit feature signal;
wherein determining, for the first unit at each of a plurality of offer values, a set of associated estimated probabilities that the offer value will be accepted within the short-term time period, is based in part on the subunit feature signal.

14. The computer-implemented method of claim 1, wherein determining the unit demand signal comprises:
processing of at least one of a type of gathering page views, email parsing, establishing an application programming interface (API) call to a third-party webpage or event logging.

15. A server comprising:
a communications module;
a processor coupled with the communications module; and
a memory coupled to the processor and storing processor-executable instructions which,
when executed by the processor, configure the processor to:
receive unit feature data for a first unit;
determine, based on the unit feature data, a unit feature signal;
receive unit demand data for the first unit at a current offer value;
determine, based on the unit demand data, a unit demand signal, the unit demand signal including predictive demand features;
determine, based on the unit feature signal and the unit demand signal, for the first unit at each of a plurality of offer values, a set of associated estimated probabilities that the offer value will be accepted within a short-term time period, the set of associated estimated probabilities comprising an associated estimated probability for each offer value;
determine, based on the set of associated estimated probabilities, an expected time-to-sell for the first unit at each of the plurality of offer values;
determine an optimal offer value for the first unit using the expected time-to-sell for the first unit at the plurality of offer values; and
display the optimal offer value for the first unit on a webpage.

16. The server of claim 15, wherein the instructions, when executed, further configure the processor to determine, based on the unit feature data, the unit feature signal by processing and combining the unit feature data into a single unit feature data score.

17. The server of claim 15, wherein the instructions, when executed, further configure the processor:
store the optimal offer value for the first unit;
transmit the optimal offer value for the first unit to a unit-owner computing device; and
receive an approval response from the unit-owner computing device.

18. The server of claim 15, wherein the instructions, when executed, further configure the processor to determine, for the first unit at each of the plurality of offer values, the set of associated estimated probabilities that the offer value will be accepted within the short-term time period, by:
determining a baseline estimated probability that the offer value will be accepted within the short-term time period.

19. The server of claim 18, wherein the instructions, when executed, further configure the processor to:
generate, using the baseline estimated probability and at least some of the predictive demand features for the first unit at the current offer value, associated sets of predictive demand features for the first unit at the plurality of offer values.

20. A non-transitory computer readable storage medium comprising computer-executable instructions which, when executed, configure a processor to:
receive unit feature data for a first unit;
determine, based on the unit feature data, a unit feature signal;
receive unit demand data for the first unit at a current offer value;
determine, based on the unit demand data, a unit demand signal, the unit demand signal including predictive demand features;
determine, based on the unit feature signal and the unit demand signal, for the first unit at each of a plurality of offer values, a set of associated estimated probabilities that the offer value will be accepted within a short-termtime period, the set of associated estimated probabilities comprising an associated estimated probability for each offer value;
determine, based on the set of associated estimated probabilities, an expected time-to-sell for the first unit at each of the plurality of offer values;
determine an optimal offer value for the first unit using the expected time-to-sell for the first unit at the plurality of offer values; and
display the optimal offer value for the first unit on a webpage.
